(19) United States
(12) Patent Application Publication
(10) Pub. No.: US 2014/0139460 A1
(43) Pub. Date: May 22, 2014

(54) TOUCH DISPLAY DEVICE AND DRIVING METHOD THEREOF

(71) Applicant: InnoLux Corporation, Miao-Li County (TW)

(72) Inventor: Ching-Hsin WU, Miao-Li County (TW)

(73) Assignee: InnoLux Corporation, Miao-Li County (TW)

(21) Appl. No.: 14/069,614

(22) Filed: Nov. 1, 2013

(30) Foreign Application Priority Data
Nov. 22, 2012 (TW) 101143613

(51) Int. Cl. G06F 3/041

(52) U.S. Cl. CPC G06F 3/0416
USPC 345/173

(57) ABSTRACT

The invention provides a touch display device, including: a lower substrate including a first inner surface and a first outer surface, wherein a thin film transistor array is formed on the first inner surface and provided with a plurality of source electrodes; an upper substrate including a second inner surface facing the lower substrate and a second outer surface; and a sensing electrode layer formed on the first outer surface and the second outer surface, wherein the plurality of source electrodes supply touch driving signals for the sensing electrode layer and the sensing electrode layer senses touch locations.

### CROSS REFERENCE TO RELATED APPLICATIONS

This Application claims priority of Taiwan Patent Application No. 101143613, filed on Nov. 22, 2012, the entirety of which is incorporated by reference herein.

### BACKGROUND OF THE INVENTION

1. Field of the Invention

The present invention relates to a touch display device and a driving method thereof, and in particular, relates to a touch display device and a driving method thereof using a source driver to output a touch driving signal.

2. Description of the Related Art

In touch display techniques, a touch sensor needs a driving electrode layer and a sensing electrode layer. A touch driving signal is output to each driving electrode disposed in the driving electrode layer successively and each sensing electrode disposed in the sensing electrode layer receives a signal and senses its variation. When a user's finger or other object touches the screen of a touch display, at the touch location, coupling capacitance generated between the electrode layers varies because capacitance generated between the finger and the electrode layers is added. The control chip then calculates the touch location by detecting the variation of the capacitance.

In this kind of structure, no matter in the case where the driving electrode layer and the sensing electrode layer are formed on the same plane and one of them is bridged to cross the other or in the case where the driving electrode layer and the sensing electrode layer are formed on opposite surfaces of a substrate, multiple photo masks are required in the manufacturing process. It is an ordeal on the yield rates and the costs.

In this regard, panel manufacturers are starting to develop single layer touch sensor to reduce manufacturing costs and thicknesses of devices. However, most of the current single layer touch sensing techniques cannot provide highly accurate multipoint touch detection, such that these techniques are only applied to low-end products. The value of the product cannot be raised.

In view of this situation, the invention provides a touch display device and a driving method thereof, which use a source driver to output a touch driving signal to lower manufacturing costs and achieve highly accurate multipoint touch detection.

### BRIEF SUMMARY OF THE INVENTION

A detailed description is given in the following embodiments with reference to the accompanying drawings.

According to an embodiment, the invention provides a touch display device, including: a lower substrate including a first inner surface and a first outer surface, wherein a thin film transistor array is formed in the first inner surface and provided with a plurality of source electrodes; an upper substrate including a second inner surface facing the lower substrate and a second outer surface; and a sensing electrode layer formed on the first outer surface or the second outer surface, wherein the plurality of source electrodes supply touch driving signals for the sensing electrode layer and the sensing electrode layer senses touch locations.

In the touch display device, the sensing electrode layer is formed from a plurality of sensing electrodes, and the arrangement direction of the sensing electrodes intersects with the arrangement direction of the source electrodes.

In the touch display device, when the sensing electrode layer is formed on the second outer surface and a common electrode layer is formed on the first or second inner surface, the common electrode layer is formed from a plurality of common electrodes of which the number and the arrangement manner correspond to the plurality of the sensing electrodes.

In the touch display device, when the plurality of source electrodes output the touch driving signals, the plurality of the common electrodes are floating.

In the touch display device, when the touch driving signals are output, a predetermined number of adjacent source electrodes are taken as a group and each group outputs one of the touch driving signals successively.

In the touch display device, the touch driving signals are output in a period for which all transistors in the thin film transistor array are nonconductive.

The touch display device further includes a gate driver receiving a clock signal and outputting gate scan signals according to the clock signal; and a source driver outputting data signals when the gate scan signal is output from the gate driver, wherein during a predetermined period for which the input of the clock signal to the gate driver is paused, the source driver outputs at least one touch driving signal.

In the touch display device, before outputting a touch driving signal, the source driver outputs a predetermined low level voltage to all of the plurality of source electrodes.

According another embodiment, the invention also provides a driving method of the touch display device including: controlling all transistors in the thin film transistor array under a nonconductive state; and taking a predetermined number of the adjacent source electrodes as a group and outputting the touch driving signal to each group successively.

The driving method further includes discharging all of the plurality of source electrodes to a predetermined low level voltage before outputting a touch driving signal.

According to the above touch display device and diving method thereof, the manufacturing cost is reduced, the yield rate is improved, and the requirements of achieving highly accurate multipoint touch is satisfied.

### BRIEF DESCRIPTION OF THE DRAWINGS

The present invention can be more fully understood by reading the subsequent detailed description and examples with references made to the accompanying drawings, wherein:

FIG. 1 is a section view of a touch display device in accordance with an embodiment of the invention;

FIG. 2 is a top view of the touch display device shown in FIG. 1;

FIG. 3 is a timing chart showing the timing of a clock signal input into the gate driver and the timing of a transition pulse signal input into the source driver in accordance with an embodiment of the invention;

FIG. 4 is a timing chart showing the timing of a clock signal input into the gate driver and the timing of a transition pulse signal input into the source driver in accordance with another embodiment of the invention; and

FIG. 5 is a schematic diagram showing source electrodes being used to output touch driving signals.

### DETAILED DESCRIPTION OF THE INVENTION

The following description is the embodiments of the invention. This description is made for the purpose of illustrating the general principles of the invention and should not be taken in a limiting sense.

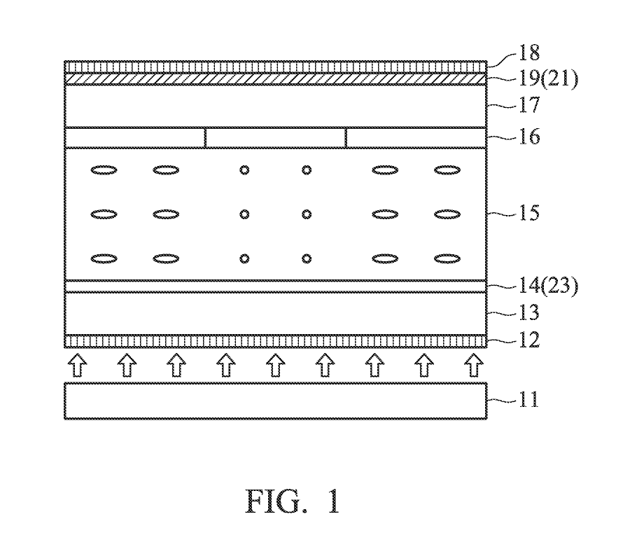

FIG. 1 is a section view of a touch display device in accordance with an embodiment of the invention. As shown in FIG. 1, a basic structure of a liquid crystal panel of the embodiment comprises: a backlight module 11, a lower polarizer 12, a lower substrate 13, a thin film transistor array 14, a liquid crystal layer 15, a color filter film 16, an upper substrate 17, and an upper polarizer 18. The structure is the same as the structure of a conventional liquid crystal panel, so detailed descriptions are omitted. The feature of the embodiment is that a sensing electrode layer 19 is formed on the outer surface of the upper substrate 17 of the conventional liquid crystal panel. The sensing electrode layer 19 comprises a plurality of sensing electrodes 21 which are used as signal receiving electrodes of a touch sensor. Source electrodes (data lines) 23 of the thin film transistor array 14 are used as signal transmitting electrodes of the touch sensor.

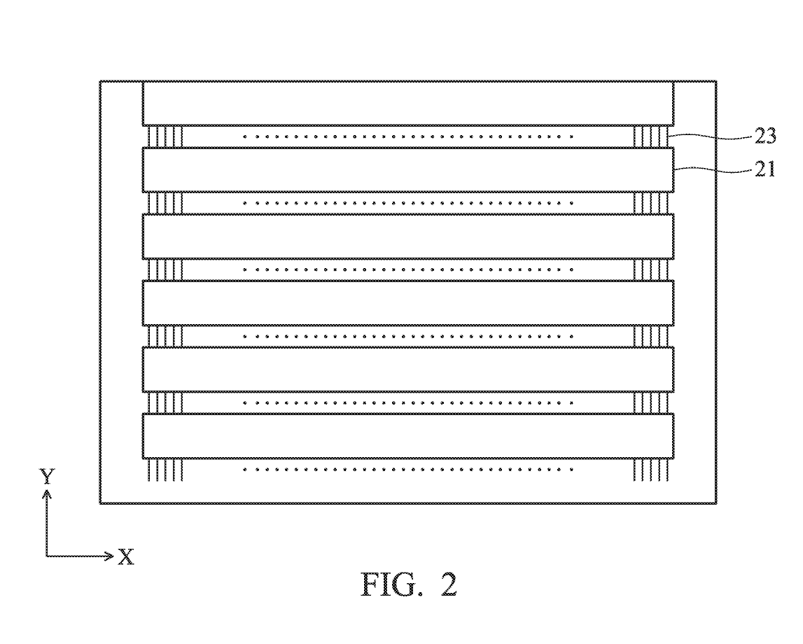

FIG. 2 is a top view of the touch display device shown in FIG. 1. In a touch sensor, the signal receiving electrodes are usually perpendicular to the signal transmitting electrodes. Therefore, in the embodiment, when the source electrodes 23 of the touch display device are parallel to a Y-direction, the sensing electrodes 21 are parallel to an X-direction. Note that it is not indispensable the sensing electrodes are perpendicular to the gate electrodes. As long as the algorithm of touch sensing is adjusted accordingly, the sensing electrodes and the gate electrodes only need to be intersecting each other.

Because the area of a touch point is much larger than the area of a pixel, the widths of the signal receiving electrode and the signal transmitting electrode in the touch sensor are made larger than those of the gate electrode (not shown) and the source electrode in the display panel. In the invention, when the source electrode is used to output the touch driving signal, a plurality of adjacent source electrodes will be taken as one signal transmitting electrode and jointly output a touch driving signal.

In this structure, the source electrodes 23 must function as data lines writing video data into each pixel and as driving electrodes outputting touch driving signals for the sensing electrode 21. The detailed driving method of the source electrodes 23 is described later.

In addition to being arranged on the outer surface of the upper substrate 17, the sensing electrode layer 19 can be arranged on the outer surface of the lower substrate 13. That is to say, the invention does not limit the arrangement of the position of the sensing electrode layer 19. It is only required that a single sensing electrode layer 19 and a liquid crystal panel form a lamination structure. Note that in an IPS (In-Plane Switching) type liquid crystal display (as shown in FIG. 1), common electrodes and source electrodes 23 are both formed on the inner surface of the lower substrate 13, so the sensing electrode layer 19 can be selectively formed on the outer surface of the upper substrate 17 or the outer surface of the lower substrate 13. However, in a VA (Vertical Alignment) type liquid crystal display, the common electrode layer is formed on the inner surface of the upper substrate (the color filter 16 side). If the sensing electrode layer 19 is formed on the outer surface of the upper substrate 17, in order to avoid the common electrode layer shielding the touch driving signals transmitted by the source electrodes 23, the common electrode layer is formed by many stripes corresponding to sensing electrodes 21, and the common electrode layer is floating when the gate electrodes 23 output touch driving signals.

According to the above embodiment, the structure of the touch display device is simpler than a conventional multi-layer structure formed from a liquid crystal panel, a driving electrode layer, a sensing electrode layer, and dielectric layers therebetween. The manufacturing cost is reduced and the yield rate is improved. Moreover, the touch driving signals outputted from the source electrodes are generated by the source driver. A driving IC for a conventional touch sensor can be reduced such that the cost is further reduced.

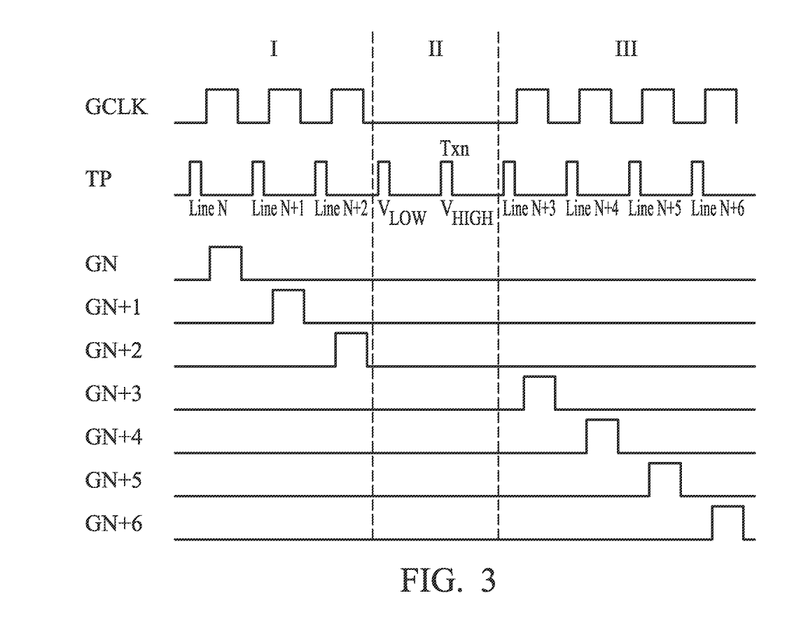

Following, a driving method of the touch display device in accordance with an embodiment of the invention is described. FIG. 3 is a timing chart showing the timing of a clock signal input into the gate driver and the timing of a transition pulse signal input into the source driver in accordance with an embodiment of the invention.

The gate driver comprises shift registers connected in series. According to a clock signal, the shift register shifts the logic level of an input signal to the next shift register and outputs it as a scan signal to the gate electrode. Take FIG. 3 for example. A gate clock signal GCLK is input to the gate driver such that the gate driver outputs scan signals GN, GN+1, GN+2, GN+3, GN+4, GN+5, GN+6 (representing scan signals of the Nth˜(N+6)th row) corresponding to each pulse of the gate clock signal GCLK.

On the other hand, according to the received transition pulse signal the source driver outputs a data signal to each source electrode (data line) to write the data into the pixel. Take FIG. 3 for example. When a pulse of the transition pulse signal TP is generated, the source driver outputs data signals of a pixel row to each source electrode. In the embodiment, because the timing for when the source driver outputs the data signal to the source electrode is delayed for a predetermined time period with respect to the timing of the generation of a pulse of the transition pulse signal TP, each pulse of the transition pulse signal TP is output before a pulse of gate clock signal GCLK such that the source driver can output data signals to each source electrode just during the period the scan signals GN, GN+1, GN+2, GN+3, GN+4, GN+5, GN+6 turn on transistors in their respective rows.

When the source electrode is used as a signal transmitting electrode of a touch sensor, the source electrode should output touch driving signals during the period for which all transistors of the thin film transistor array are nonconductive. Otherwise, the touch driving signal may be treated as a data signal and written into the pixel connected to the conductive transistor. Take FIG. 3 for example. The gate clock signal GCLK is input to the gate driver normally during the periods I and III, but the input of the gate clock signal GCLK to the gate driver is paused during the period II. Therefore, no transistors are turned on during the period II, such that the source electrode can transmit the touch driving signal during the period II.

The voltage level of the source electrode is different from the others because it is affected by a previous signal. In this regard, a low level voltage, such as 0V, should be output to initialize voltage levels of all source electrodes before a touch driving signal is output. Then a high level touch driving signal is output to the source electrode used as the signal transmitting electrode. Take FIG. 3 for example. During period II, when the n-th touch driving signal Txn is output to the source electrode, the first pulse of the transition pulse signal TP enables the source driver to output a low level voltage V_{LOW}for initialization, and the second pulse of the transition pulse signal TP enables the source driver to output a high level voltage V_{HIGH} as the touch driving signal Txn. In this way, the source electrode can transmit the touch driving signal Txn during the period for when the gate clock signal stops inputting to the gate driver.

In the example of FIG. 3, the period the gate clock signal GCLK is paused in inputting to the gate driver, namely the period II, is approximately equal to the time period for two pulses. However, the invention is not limited thereto. As long as the period II is long enough for at least one touch driving signal to be output (including a low level voltage V_{LOW} and a high level voltage V_{HIGH}), the period II can be elongated for more than one touch driving signals to be output.

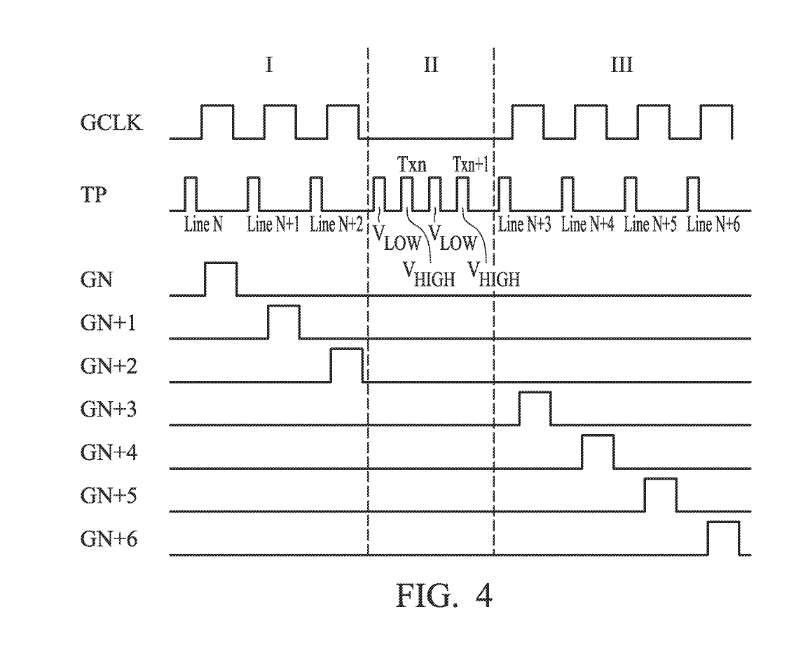

Not only the period II, during which the input of the gate clock signal GCLK is paused, but also the frequency of the transition pulse signal TP can be adjusted. For example, the frequency of the transition pulse signal TP is increased during the period for which the touch driving signals are output. As shown in FIG. 4, in period II the frequency of the transition pulse signal TP is increased such that 4 pulses are output. In this case, the source electrode outputs 2 touch driving signals Txn and Txn+1. Certainly, the invention can shorten the period II during which the input of the gate clock signal GCLK is paused and in the meantime increase the frequency of the transition pulse signal TP during period II.

Assuming that a horizontal scan period is 20 μs. If the first 10 μs is a period the scan signal turns on the transistors, then the timing the touch driving signal is output can be arranged in the second 10 μs. This design is practicable because outputting a touch driving signal of a conventional touch sensor only needs 3 μs. Therefore, the invention can evenly distribute the timing of the output of the touch driving signal into the period between different scan signals without pausing the input of the gate clock signal GCLK.

According to the above driving method of the touch display device, only the gate clock signal input to the gate driver and/or the transition pulse signal input to the source driver are modified, and the source electrodes can transmit touch driving signals to perform touch scanning. Therefore, the invention uses already existing source electrodes and a source driver to perform touch scanning. The invention substantially reduces the manufacturing cost and provides precise multipoint touch.

Following, a specific example is provided to describe the touch display device of the invention and the driving method thereof.

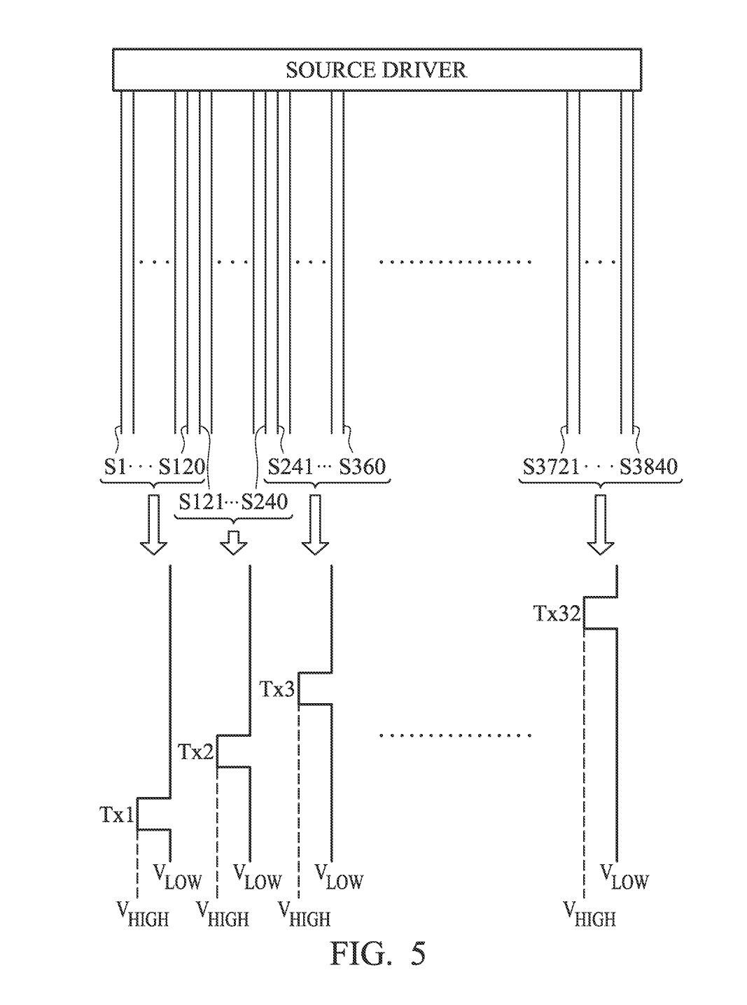

FIG. 5 is a schematic diagram showing source electrodes being used to output touch driving signals. It is assumed that a 1280×800 resolution display panel (the total number of the source electrodes is 1280×3=3840) needs 32 signal transmitting electrodes of a touch sensor. Therefore, every 120 source electrodes must be used as one signal transmitting electrode. As shown in FIG. 5, the 1^{st}˜120^{th} source electrodes S1˜S120 are used as the first signal transmitting electrode of the touch sensor and jointly output the first touch driving signal Tx1. The 121^{st}˜240^{th} source electrodes S121˜S240 are used as the second signal transmitting electrode of the touch sensor and jointly output the second touch driving signal Tx2. The 3721^{st}˜3840^{th} source electrodes S3721˜S3840 are used as the thirty-second signal transmitting electrode of the touch sensor and jointly output the thirty-second touch driving signal Tx32. Thereby, the arrangement of all signal transmitting electrodes and the outputting manner of touch driving signals are implemented.

In the above structure, when the first touch driving signal Tx1 is to be output, the 1^{st}˜3840^{th} source electrodes S1˜S3840 are driven (discharged) to a low voltage level V_{LOW}, and then the 1^{st}˜120^{th} source electrodes S1˜S120 are driven to a high voltage level V_{HIGH}. When the second touch driving signal Tx2 is to be output, the 1^{st}˜3840^{th} source electrodes S1˜S3840 are driven (discharged) to a low voltage level V_{LOW}, and then the 121^{st}˜240^{th} source electrodes S121˜S240 are driven to a high voltage level V_{HIGH.} In the same manner when the thirty-second touch driving signal Tx32 is to be output, the 1^{st}˜3840^{th} source electrodes S1˜S3840 are driven (discharged) to a low voltage level V_{LOW}, and then the 3721^{st}˜3840^{th} source electrodes S3721˜S3840 are driven to a high voltage level V_{HIGH}. In this way, a touch scanning operation for an entire touch area is performed.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). For example, the number of source electrodes taken as a signal transmitting electrode, the interval between two touch driving signals, and etc. can be modified appropriately according the requirements of different kinds of products.

What is claimed is:

1. A touch display device, comprising:
a lower substrate comprising a first inner surface and a first outer surface, wherein a thin film transistor array is formed on the first inner surface and provided with a plurality of source electrodes;
an upper substrate comprising a second inner surface facing the lower substrate and a second outer surface; and
a sensing electrode layer formed on the first outer surface or the second outer surface,
wherein the plurality of source electrodes supply touch driving signals for the sensing electrode layer and the sensing electrode layer senses touch locations.

2. The touch display device as claimed in claim 1, wherein the sensing electrode layer is formed from a plurality of sensing electrodes, and the arrangement direction of the sensing electrodes intersects with the arrangement direction of the source electrodes.

3. The touch display device as claimed in claim 2, wherein when the sensing electrode layer is formed on the second outer surface and a common electrode layer is formed on the first or second inner surface, the common electrode layer is formed from a plurality of common electrodes of which the number and the arrangement manner correspond to the plurality of the sensing electrodes.

4. The touch display device as claimed in claim 3, wherein when the plurality of source electrodes output the touch driving signals, the plurality of the common electrodes are floating.

5. The touch display device as claimed in claim 1, wherein when the touch driving signals are output, a predetermined number of adjacent source electrodes are taken as a group and each group outputs one of the touch driving signals successively.

6. The touch display device as claimed in claim 1, wherein the touch driving signals are output in a period for which all transistors in the thin film transistor array are nonconductive.

7. The touch display device as claimed in claim 1, further comprising:
a gate driver receiving a clock signal and outputting gate scan signals according to the clock signal; and
a source driver outputting data signals when the gate scan signal is output form the gate driver,
wherein during a predetermined period for which the input of the clock signal to the gate driver is paused, the source driver outputs at least one touch driving signal.

8. The touch display device as claimed in claim 7, wherein before outputting a touch driving signal, the source driver outputs a predetermined low level voltage to all of the plurality of source electrodes.

9. A driving method of the touch display device as claimed in claim 1, comprising:
controlling all transistors in the thin film transistor array under a nonconductive state; and
taking a predetermined number of the adjacent source electrodes as a group and outputting the touch driving signal to each group successively.

10. The driving method as claimed in claim 9, further comprising:
discharging all of the plurality of source electrodes to a predetermined low level voltage before outputting a touch driving signal.
